(19) United States
(12) Patent Application Publication
(10) Pub. No.: US 2023/0017412 A1
(43) Pub. Date: Jan. 19, 2023

(54) Receiving Unit for Receiving a Fluid, Method and Apparatus for Producing a Receiving Unit, Method and Apparatus for Operating a Receiving Unit, and Receiving Device

(71) Applicant: Robert Bosch GmbH, Stuttgart (DE)

(72) Inventor: Daniel Sebastian Podbiel, Rutesheim (DE)

(21) Appl. No.: 17/757,649

(22) PCT Filed: Dec. 17, 2020
(86) PCT No.: PCT/EP2020/086753

§ 371 Date: Jun. 17, 2022

(30) Foreign Application Priority Data
Dec. 18, 2019 (DE) 10 2019 220 017.6

(51) Int. Cl. B01L 3/00

(52) U.S. Cl. CPC B01L 3/502707; B01L 3/502769; B01L 2200/0642; B01L 2200/0689; B01L 2200/16; B01L 2300/0803; B01L 2300/0864; B01L 2300/0893; B01L 2300/161; B01J 2219/00317

(57) ABSTRACT

A receiving unit for receiving a fluid has a receiving element with a receiving face and at least one micro-cavity that is arranged and formed in the receiving element on the receiving face in order to receive the fluid. The receiving face further has a hydrophilic surface characteristic in at least one subregion adjoining the at least one micro-cavity.

### PRIOR ART

The invention starts from a receiving unit for receiving a fluid, a method and an apparatus for producing a receiving unit, a method and an apparatus for operating a receiving unit, and a receiving device, according to the preamble of the independent claims. Another subject of the present invention is a computer program.

For molecular diagnostics tests at what is termed a point of care, suitability is possessed in particular by microfluidic analytical systems, known as lab on chips, which permit fully automated analysis of patient samples. Complex tests frequently require implementation of a number of detection reactions, independent of one another, in order to address different targets in a sample for study.

### DISCLOSURE OF THE INVENTION

Against this background, the approach presented here presents an improved receiving unit, improved methods, furthermore improved apparatuses which use these methods, and lastly a corresponding computer program, according to the main claims. The measures set out in the dependent claims enable advantageous developments and improvements of the apparatus specified in the independent claim.

The approach presented here allows for more reliable filling of micro-cavities relative to the prior art, in combination with a simple introduction and storage of reagents dried in the micro-cavities, and prevents risk of entrainment of reagents stored in the micro-cavities during the controlled filling of the micro-cavities with a fluid, such as a sample liquid, for example. Sealing of the micro-cavities filled with sample liquid using a second fluid, i.e., a suitable sealing liquid, likewise prohibits cross-talk between reactions taking place in the fluid-filled micro-cavities, in order, for example, for different amplification reactions independent of one another to be carried out in the micro-cavities for detecting different DNA targets, for example.

A receiving unit is presented for receiving a fluid, and has a receiving element with a receiving face having at least one micro-cavity which in the receiving element is arranged on the receiving face and is shaped to receive the fluid, and which, at least in a subregion of the receiving face bordering the at least one micro-cavity, has a hydrophilic surface character.

The receiving unit may be used, for example, in a receiving device designed to test samples, for example. The fluid may be realized, for example, as a liquid, such as a sample liquid, for example. The sample liquid may be, for example, an aqueous solution, obtained for example from a biological substance, of human origin, for example, such as a body fluid, a smear, a secretion, sputum, a tissue sample, or an apparatus with sample material attached. Present in the sample liquid are, for example, species of medical, clinical, diagnostic or therapeutic relevance, such as, for example, bacteria, viruses, cells, circulating tumor cells, cell-free DNA, proteins or other biomarkers or, in particular, constituents of the stated objects.

The sample liquid is, for example, a master mix or constituents thereof, for the implementation, for example, of at least one amplification reaction in the receiving element, for DNA detection at molecular level, for example, such as an isothermal amplification reaction or a polymerase chain reaction, for example. The receiving element is shaped more particularly as a sample carrier whose receiving face, for example, at least in a subregion bordering the at least one micro-cavity, is of hydrophilic character. The micro-cavity arranged in the receiving face may also be designated, for example, as a cavity or recess being distinguished more particularly as a cavity having dimensions in the sub-millimeter range. The micro-cavity may accordingly have a hollow space to allow the fluid to be received. The micro-cavity may further possess a surface character which is inert and exhibits high biocompatibility, for the implementation therein, for example, of a molecular DNA detection reaction such as an isothermal amplification reaction or a polymerase chain reaction, for example. For the functionality of the apparatus, more particularly for the overlayering of the aqueous phase present in the micro-cavities with a second, immiscible phase, capillary forces and surface forces, for example, are important. This functionality cannot be guaranteed for large macroscopic cavities.

The receiving unit according to one particularly advantageous embodiment has a plurality of further micro-cavities, which in the receiving element may be arranged on the receiving face and may be shaped to receive the fluid. In this case the micro-cavity and the plurality of further micro-cavities may be arranged in an arrangement region, more particularly a square, circular, rectangular or oval region of the receiving face, more particularly with a mandated distance from the edge of the receiving face, more particularly according to a hexagonal, square or rectangular scheme, where more particularly between the micro-cavity and the plurality of further micro-cavities the receiving face has a hydrophilic surface character. By virtue of a mandated distance of the outer limit of the arrangement region from the edge of the receiving face, i.e., the outer edge of the receiving unit, the outer region, referred to as the spacing region, may be utilized for handling of the receiving unit with an automatic charger (pick-and-place robot) during fabrication for example, without the automatic charger (pick-and-place robot) coming into contact with the arrangement region of the micro-cavities, which is particularly relevant for the functionality of the receiving unit, and possibly leading there to possible contamination of the surface or of the micro-cavities. By means of an arrangement of the micro-cavities according to a hexagonal scheme, a particularly high surface density of the micro-cavities can be achieved with a constant distance between adjacent micro-cavities. By virtue of an arrangement of the cavities in a square or rectangular scheme, the assignment of the cavities can be particularly simple. In one advantageous embodiment the receiving unit has further structures, more particularly structures bordering the receiving face outside the arrangement region of the cavities as well, these structures serving for assignment or referencing of the micro-cavities. The structures in question are, for example, alignment marks for the standardized introduction of reagents into the micro-cavities by means of an array spotting system, such as a piezo-based precision dispensing system, for example, or for the assignment of the cavities in an optical reader which detects, for example, fluorescence signals emanating from the detection reactions in the micro-cavities of the receiving unit. Also conceivable, furthermore, is for different reagents to be introduced into or held in the different micro-cavities, allowing, for example, different detection reactions to be performed in the micro-cavities.

According to one embodiment the micro-cavity may have at least one side wall aligned substantially perpendicular to the receiving face. Usefully it is also possible for all the side walls of the micro-cavity to be aligned substantially perpendicular to the receiving face. This enables, for example, particularly simple manufacture of the receiving element. The substantially perpendicularly aligned side wall/side walls may have an angle of 80° to 100° with respect to the receiving face, for example. As a result it is possible advantageously—in combination with a mandated suitable aspect ratio of the micro-cavity and/or using an additive which has been introduced into the micro-cavity-to reduce entrainment or discharge of reagents stored in the micro-cavity, for example, during filling to less than 10%, for example, of the amount held in the micro-cavity. More particularly it is possible, for example, to store DNA target-specific primers and/or probes in the at least one micro-cavity, to implement at least one specific detection reaction therein.

According to one embodiment a micro-cavity contains at least a stored reagent and/or additive. A “reagent” may be understood to be a substance which is used for implementing a specific reaction in the micro-cavity. An “additive”, conversely, may be understood as a substance which is present in general in multiple cavities and which enables filling of the micro-cavity and/or relatively minor entrainment of stored reagent. The “additive”, accordingly, is critical in particular to the fluidic functionality, whereas the “reagent” is critical in particular to the precise detection reaction. By the storing of an additive in the micro-cavity it is possible in particular, advantageously, to prevent unwanted inclusion of air in the micro-cavity and more particularly at the bottom of the micro-cavity when the micro-cavity is being wetted and filled with the sample liquid. Furthermore, by means of the at least one stored reagent, it is possible to produce a predetermined, desired reaction with the fluid, i.e., more particularly, with a sample liquid and more particularly particular constituents of the sample liquid, referred to as targets, allowing the sample fluid to be studied for the presence of particular features.

With particular advantage the receiving unit possesses a plurality of micro-cavities in which at least two different detection reactions can be implemented for detecting at least two different targets. In this way it is possible to implement, in the receiving unit, highly complex molecular diagnostics tests, which address a multiplicity of different targets with a multiplicity of different detection reactions. An advantage here in particular is that detection reactions with reduced multiplex performance can also be used to implement detections in the singleplex format in the individual fluid partitions in the micro-cavities (geometric multiplexing). With particular advantage isothermal DNA detection reactions independent of one another can be implemented in the micro-cavities, these reactions possibly having on the one hand a high reaction rate but on the other hand only a low multiplex compatibility (as a result, for example, of unwanted interactions between primers and/or probes). In this way a receiving unit having multiple cavities can be used with particular advantage for the implementation therein of rapid DNA high-multiplex testing using isothermal detection reactions in the singleplex format. In particular, prior to the array-based detection in the singleplex format, there is a preliminary multiplex amplification, more particularly by polymerase chain reactions, to increase the sensitivity of the sample analysis. The detection time for preliminary multiplex amplification and for the singleplex detection of multiple DNA targets in the receiving unit here is, in particular, less than 60 minutes; the detection time for the singleplex detection of multiple DNA targets in the receiving unit is less than 30 minutes.

In summary, the receiving unit of the invention enables very simple and rapid study of the sample liquid for a multiplicity of different targets in an individual apparatus, including, more particularly, using detection reactions having a limited multiplex capability. Advantageously the use of the receiving unit likewise enables easy adaptation of multiplex tests, i.e., more particularly, the addition of a detection reaction to a multiplex test, since the detection reactions take place independently of one another in the micro-cavities of the receiving unit and accordingly there can be no significant interactions between the different primers and probes used in the plurality of micro-cavities.

The receiving face may be designed at least partly as a silicon nitride layer and/or silicon oxide layer and/or as a silane layer, for example, as a polyethylene glycol-silane layer. As a result of the hydrophilicity of the receiving face, advantageously, penetration of the fluid into the at least one micro-cavity can be enabled or significantly improved, and a receiving face of this kind can be produced with technically simple and cost-effective methods which are also well-established. Furthermore, because of the improved penetration of the fluid into the micro-cavity, especially in combination with storage of at least one reagent in the micro-cavity, more particularly of an additive, and/or by hydrophilic coating of the micro-cavity, the receiving element can be used in combination with a microfluidic apparatus in order to enable fully automated introduction of the fluid into the at least one micro-cavity of the receiving unit.

According to a further embodiment the receiving element and/or the receiving unit may also be formed of a silicon substrate. The silicon substrate may be realized, for example, as a silicon wafer. In this way it is possible for example to lower materials costs in the context, for example, of fabrication, since such substrates are already used in semiconductor technology and it is therefore possible to employ semiconductor technology fabrication methods for the fabrication of the approach presented here. In particular a plurality of receiving units can be fabricated in parallel through the processing of a silicon wafer. Furthermore, in the context of the method described below for producing the receiving unit, predetermined breakage points can be introduced into the silicon substrate simultaneously with the etching of the micro-cavities. In this way, through mechanical breaking of the silicon substrate, the silicon substrate can be singularized in a particularly simple and cost-effective way into a plurality of receiving units, thereby enabling cost-effective production of the receiving units. Furthermore, through use of silicon as substrate material for the receiving unit, it is possible in particular to achieve especially uniform and rapid temperature conditioning of the micro-cavities, since silicon has a high thermal conductivity. High comparability and rapid implementability of the individual detection reactions are provided for in this way.

According to one embodiment the receiving unit may have a further plurality of micro-cavities, which in the receiving element may be arranged on the receiving face and may be shaped to receive the fluid; the further plurality of micro-cavities may be arranged in a further arrangement region, more particularly in a square, circular, rectangular or oval region of the receiving face, more particularly with a mandated distance from the edge of the receiving face, more particularly according to a hexagonal, square or rectangular scheme. Between the arrangement region and the further arrangement region in this case there may be a spacing region arranged in which no micro-cavities are provided. In this case it is possible again to use multiple groups of micro-cavities for the purpose of implementing a multiplex test—if, for example, the individual micro-cavities are provided with different reagents held therein. Advantageously in this way it is possible for example to implement a plurality of tests synchronously, by virtue of further reagents, for example, being stored in the further plurality of micro-cavities.

According to one embodiment the spacing region may have a width which may correspond, for example, at least to twice the minimum distance of adjacent micro-cavities of the arrangement region or the further arrangement region. As a result the arrangement regions may advantageously be differentiated from one another in a markedly perceptible way, so facilitating an evaluation of the individual groups of micro-cavities. The spacing region is also beneficial to handling of the chips after the singularization of the receiving unit.

According to one embodiment the micro-cavities or groups of micro-cavities have different dimensions and/or different volumes. By means of different volumes of sample liquid in the individual micro-cavities, i.e., reaction compartments, there are different numbers of target units, DNA copies for example, present, considered statistically, in the different-sized compartments. For detection reactions with a high sensitivity, accordingly, smaller reaction compartments can be used, whereas larger reaction compartments can be used for detection reactions having a low sensitivity, to achieve reliable detection of different targets in the sample liquid using specific detection reactions with different detection characteristics. Moreover, when using a digital detection methodology, a greater quantification range can be achieved in this way.

According to one embodiment the receiving face may have an optically detectable feature, which may have a predefined position relative to the arrangement of the at least one micro-cavity, more particularly wherein the optically detectable feature may have a predetermined character in relation to its size and/or optical properties. In this way advantageously an automated legibility can be improved, because, for example, reference points can be labeled.

Further presented is a receiving device which has a receiving unit in one of the variants presented above, a housing for accommodating the receiving unit, a chamber for introducing at least one fluid, a sample liquid for example, into at least one micro-cavity of the receiving unit and optionally for subsequently introducing a second fluid, i.e., a sealing liquid which has only slight miscibility or none with the sample liquid and permits overlayering/sealing of the sample liquid enclosed in the micro-cavities of the receiving device, and also at least one channel designed to carry the sample liquid to the micro-cavities of the receiving unit and subsequently to overlayer the micro-cavities with the sealing liquid and/or to enable venting and/or to carry off excess sample liquid and sealing liquid.

The housing may for example be shaped to protect the receiving unit and the sample liquid from environmental effects and/or conversely to prevent contamination of the environment by the sample liquid. The channel may be realized for example in the form of a tube or hose and may have for example a virtually rectangular cross section. The receiving device may be fabricated for example cost-effectively from a polymer material such as, for example, polycarbonate (PC), polypropylene (PP), polyethylene (PE), cycloolefin copolymer (COP, COC), polymethyl methacrylate (PMMA), polydimethylsiloxane (PDMS) or thermoplastic elastomers (TPE) such as polyurethane (TPU) or styrene block copolymer (TPS) or from a combination of polymer materials and may be produced by high-throughput methods such as, for example, injection molding, thermoforming, punching and/or using joining technologies such as laser irradiation welding, for example.

The receiving device may optionally have a pump device, which may be designed to pump the at least one fluid, the sample liquid and/or the sealing liquid for example, through the channel. In this way advantageously a fully automated microfluidic processing can be enabled. The pump device may be actuated for example by a processing unit by way of a pneumatic interface. The pump device is based more particularly on an elastic membrane which is integrated into the receiving device and which by application of an overpressure or underpressure can be diverted into recesses within the receiving device, allowing controlled displacement of the sample liquid or sealing liquid to be achieved. In this way, microfluidic elements such as pump chambers and valves can be realized. Through a suitable sequential actuation of multiple elements of the pump device, it is possible to achieve controlled transport of the sample liquid and sealing liquid, in particular using peristaltic pumping mechanisms. The receiving device further possesses, in particular, at least one opening for the input of the sample and optionally a further opening which serves as a vent. In one advantageous embodiment the receiving device has further recesses for the storage of liquid or solid reagents, and a microfluidic network which serves for the processing of the reagents within the receiving device.

Additionally presented is a method for producing a receiving unit in one of the variants presented above, the method comprising a step of providing and a step of introducing. In the step of providing, the receiving face of the receiving element is provided. In the step of introducing, the at least one micro-cavity is introduced into the receiving face for receiving the fluid, to produce the receiving unit.

Alternatively or additionally it is also possible furthermore in the step of introducing, in a substep, to apply a photoresist layer/a photoresist and/or to provide a lithography substep and also to carry out structuring using deep reactive ion etching (Bosch process) in order to introduce the micro-cavities (and/or further optically detectable features). The photoresist may be applied for example by spin coating and exposed in the lithography step before excess material can be removed. Following the introduction of the at least one micro-cavity, the receiving element may be treated, for example, such that excess photoresist, for example, can be removed. Alternatively or additionally it is also possible, in an optional step, for the receiving face and/or the micro-cavities to be coated to produce a hydrophilic surface character of the receiving face and/or micro-cavities.

In the method, therefore, optionally, a surface character of the receiving face and/or the micro-cavities can be modified in such a way that it becomes hydrophilic, by being formed, for example, as a silicon nitride surface or as a silicon oxide surface and/or as a silane layer, for example, as a polyethylene glycol-silane layer. It is particularly useful if alternatively or additionally, in a further optional step, reagents are introduced into the micro-cavity(ies) of the receiving unit. The method may optionally comprise a step of dividing, in which, for example, the receiving element may be divided. The dividing may be achieved more particularly by introduction of predetermined breakage points into the receiving face of the receiving element, this taking place advantageously together with the introduction of the micro-cavities, and by subsequent mechanical breaking.

Further presented is a method for operating a receiving unit in one of the variants stated above, the method comprising a step of filling and sealing, a step of implementing, and a step of evaluating. In the step of filling and sealing, at least one micro-cavity is first filled with a sample liquid and then overlayered with a sealing liquid as second fluid, and so in the at least one micro-cavity there is a partition of the sample liquid as fluidic reaction compartment. The sealing liquid is, for example, a liquid having a low water solubility, to prohibit unwanted mixing with the sample liquid, and/or a low viscosity, to achieve high mobility, i.e., effective removal of gas bubbles which form during thermal processing of the apparatus, for example, and/or low thermal conductivity, to minimize the parasitic heat losses that occur in the case of temperature conditioning, and/or a low heat capacity, to minimize the thermal mass to be processed-in the case of the implementation of a polymerase chain reaction, for example—and/or with included surfactants, to stabilize the interface to the sample liquid. The sealing liquid is, for example, a fluorinated hydrocarbon.

In the step of implementing, at least one reaction is implemented in the at least one micro-cavity to obtain a reaction result. For the implementation of the at least one reaction, the receiving element, and more particularly the reaction compartment present in the at least one micro-cavity, has in particular a mandated temperature which enables the reaction to proceed, the reaction being an isothermal amplification reaction, for example. In the step of implementing there is optionally thermal cycling of the receiving apparatus, to implement a polymerase chain reaction in the at least one reaction compartment, for example. In the step of implementing, in particular, a fluorescence signal emanating from the at least one reaction compartment is also captured, which suggests that a reaction is proceeding.

In the step of evaluating, the reaction result is evaluated. The step of evaluating takes place more particularly on the basis of the fluorescence signal captured in the step of implementing. Advantageously the reaction result is already evaluated parallel with the implementation of the at least one reaction on the basis of the fluorescence signal profile, and the implementation of the reaction is halted as soon as the reaction result can be ascertained with sufficient accuracy.

In a particularly useful working example of the method presented here, detection reactions that are independent of one another, more particularly different detection reactions, are implemented in the micro-cavities. Alternatively or additionally a step of a preliminary multiplex amplification of the sample material may be performed, and a subsequent detection of targets in the singleplex array format, in a variant of the receiving unit presented here.

Variants of the methods presented here may be implemented for example in software and/or hardware or in a hybrid form of software and hardware—for example, in a controller.

The approach presented here further provides an apparatus designed to implement, activate or realize the steps of a variant of one of the methods presented here, in corresponding devices. This variant embodiment of the invention in the form of an apparatus also allows the object on which the invention is based to be achieved rapidly and efficiently.

For this purpose the apparatus may have at least one computing unit for processing signals or data, at least one memory unit for storing signals or data, at least one interface to a sensor or an actuator for reading—in sensor signals from the sensor or for outputting data signals or control signals to the actuator, and/or at least one communications interface for reading—in or outputting data, which are embedded in a communications protocol. The computing unit may be, for example, a signal processor, a microcontroller or the like, where the memory unit may be a flash memory, an EEPROM or a magnetic storage unit. The communications interface may be designed to read—in or output data wirelessly and/or in line-bound manner, in which case a communications interface which is able to read—in or output line-bound data may read in these data for example electrically or optically from a corresponding data transmission line or may output them into a corresponding data transmission line.

An apparatus may be understood presently to mean an electrical device which processes sensor signals and, in dependence thereon, outputs control signals and/or data signals. The apparatus may have an interface, which may be designed in hardware and/or software terms. In the case of a hardware-based embodiment, the interfaces may for example be part of what is called a system ASIC, which includes a wide variety of different functions of the apparatus. It is, however, also possible for the interfaces to be dedicated, integrated circuits or to consist at least partly of discrete components. In the case of a software-based embodiment, the interfaces may be software modules, which are present for example on a microcontroller along with other software modules.

In one advantageous configuration the apparatus is responsible for controlling a method for operating a receiving unit. For this purpose the apparatus may access, for example, sensor signals such as a read—in signal, which represents read—in information, and/or a control signal, to activate the steps of one of the methods. Activation is accomplished via actuators such as a read—in unit, an evaluation unit and/or a providing unit.

Also advantageous is a computer program product or computer program with program code which can be stored on a machine-readable carrier or storage medium such as a semiconductor memory, a hard disk storage unit or an optical storage unit and which is used for implementing, realizing and/or activating the steps of the method according to one of the above-described embodiments, more particularly if the program product or program is run on a computer or an apparatus.

Exemplary embodiments of the approach presented here are represented in the drawings and explained in more detail in the description hereinafter. In the drawings:

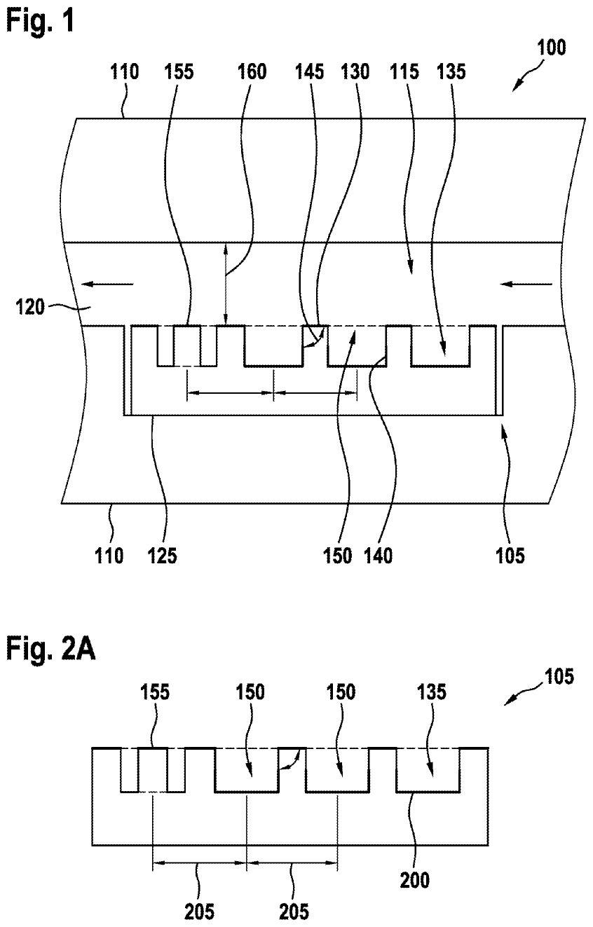

FIG. 1 shows a schematic side representation of a receiving device according to one exemplary embodiment;

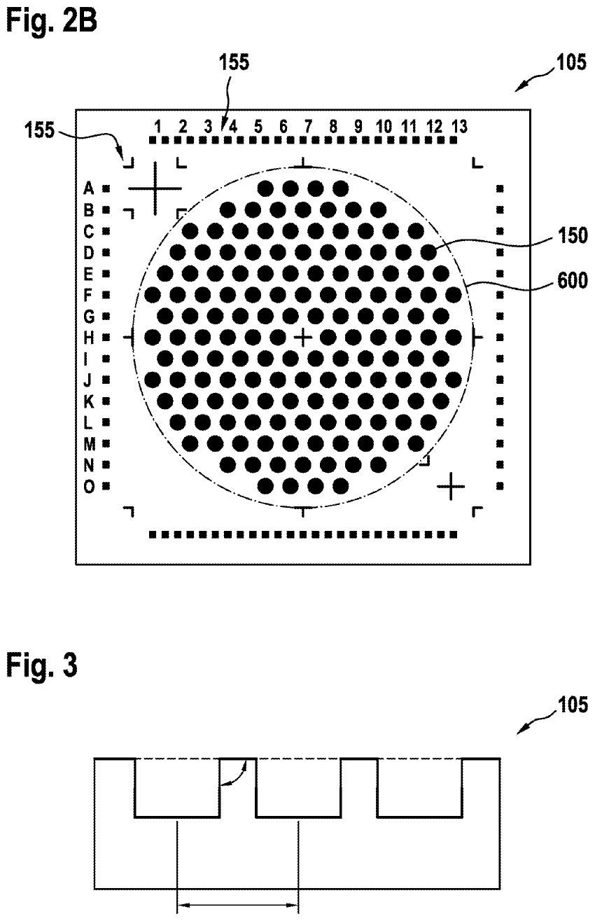

FIG. 2A shows a schematic side representation of a receiving unit according to one exemplary embodiment;

FIG. 2B shows a schematic representation in plan view of a receiving unit according to one exemplary embodiment;

FIG. 3 shows a schematic side representation of a receiving unit according to one exemplary embodiment;

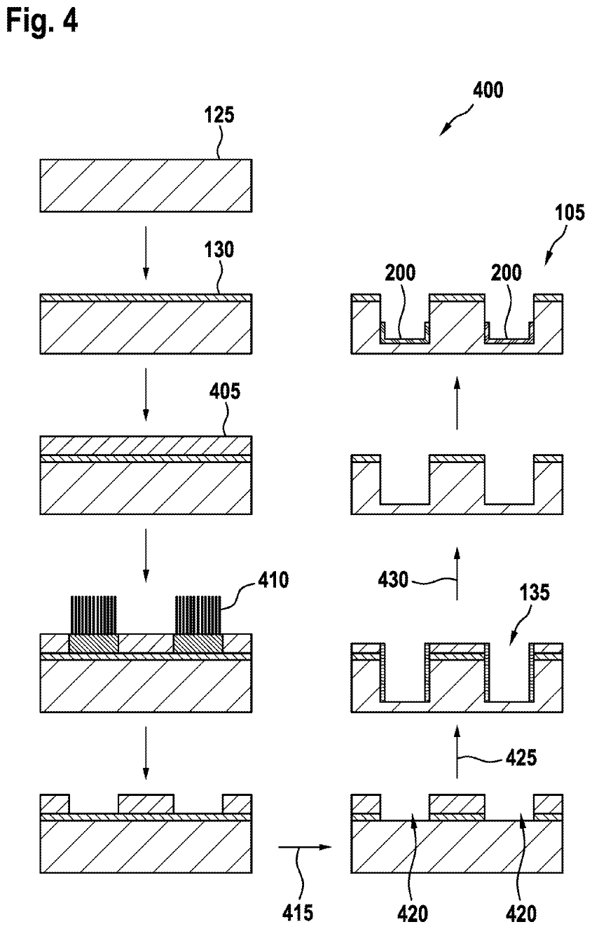

FIG. 4 shows a schematic representation of different stages of intermediates in a possible production process for a receiving unit according to one exemplary embodiment;

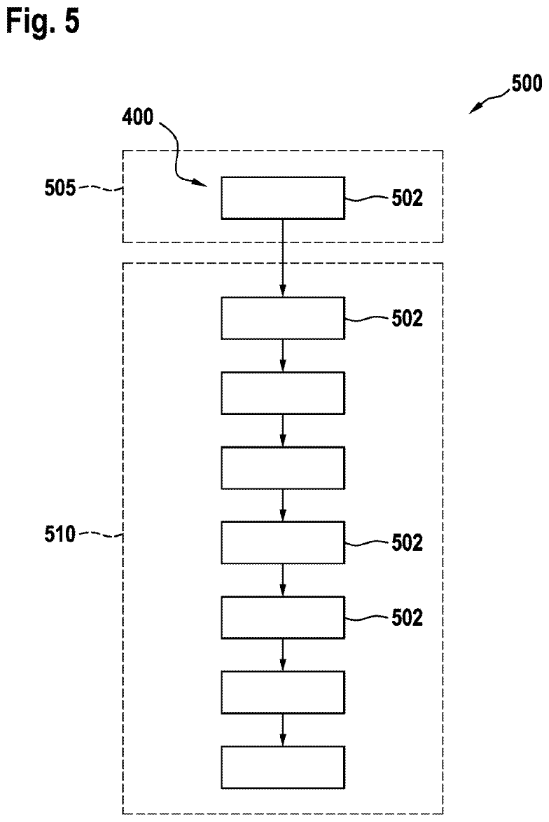

FIG. 5 shows a flow diagram of a method for producing a receiving unit according to one exemplary embodiment;

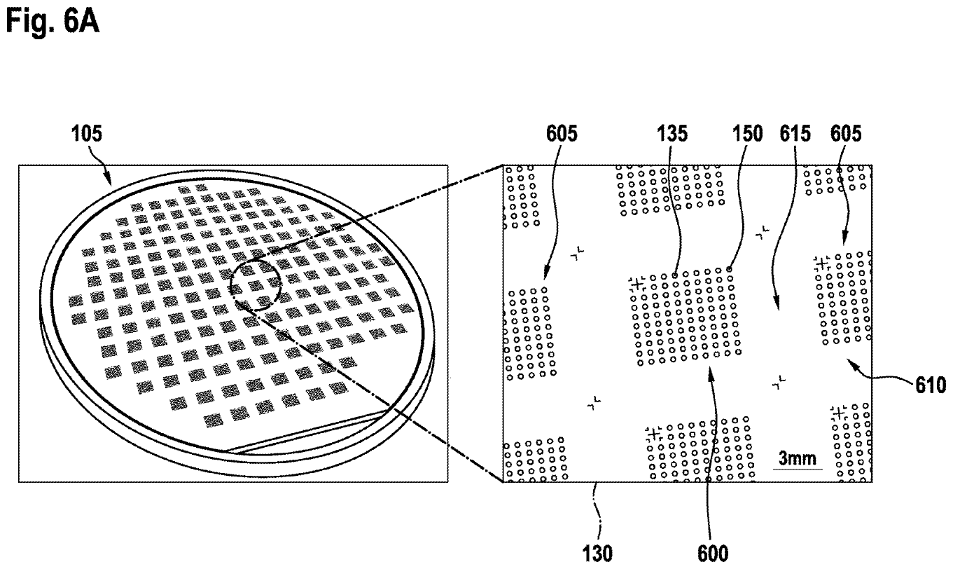

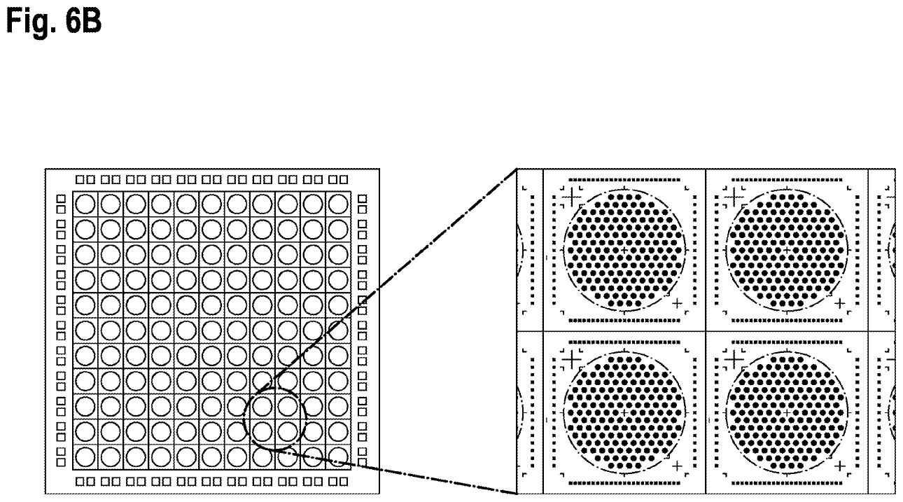

FIG. 6A shows a perspective representation of a receiving unit according to one exemplary embodiment;

FIG. 6B shows a perspective representation of a receiving unit according to a further exemplary embodiment;

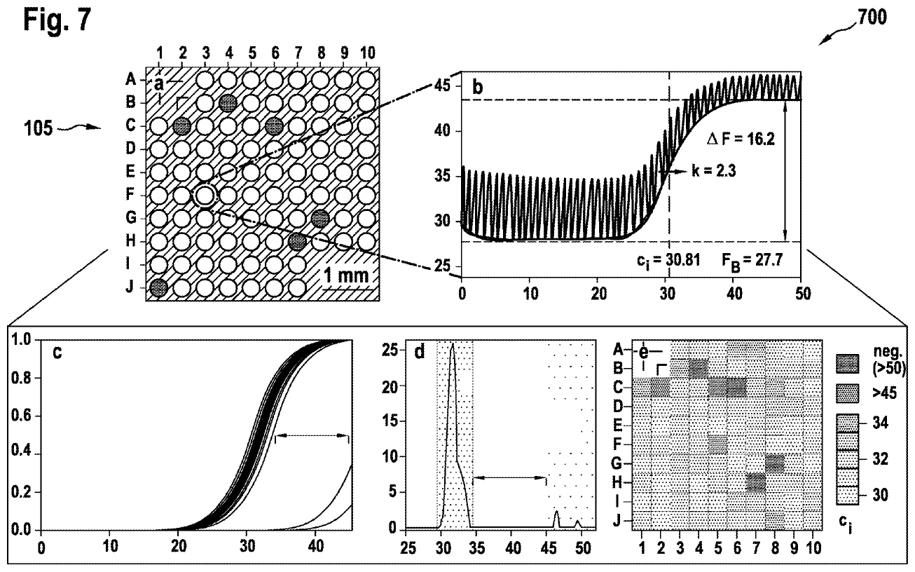

FIG. 7 shows a representation for explaining the procedure for ascertaining a reaction result of a polymerase chain reaction obtained in a receiving unit according to one exemplary embodiment;

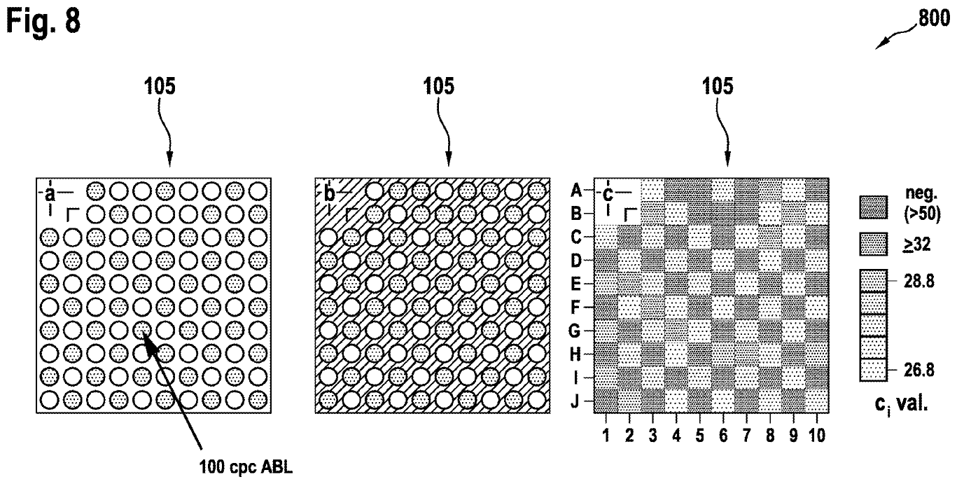

FIG. 8 shows a representation of a reaction result obtained in a receiving unit according to one exemplary embodiment, after an entrainment test;

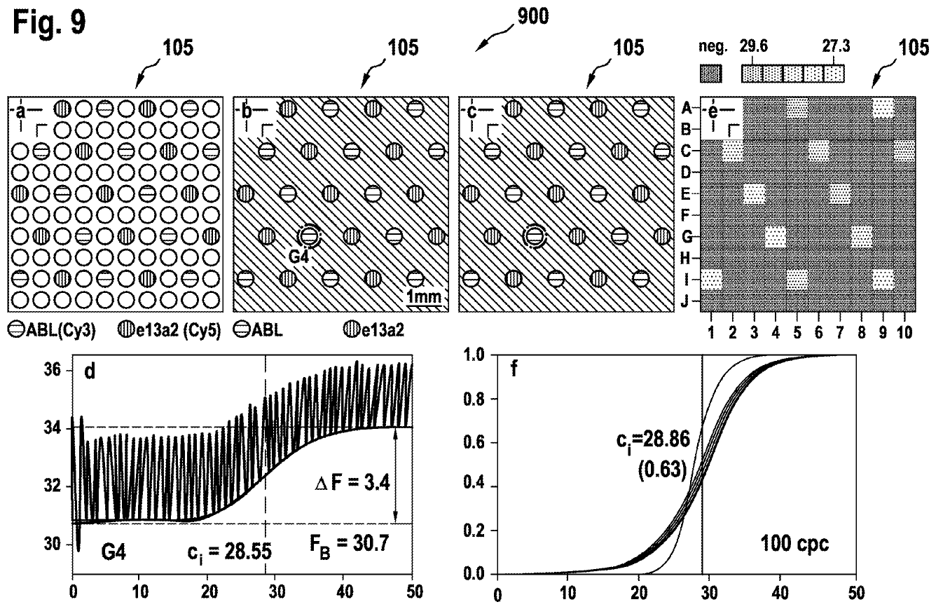

FIG. 9 shows a representation for explaining the procedure for ascertaining a reaction result of a multiplex test obtained in a receiving unit according to one exemplary embodiment;

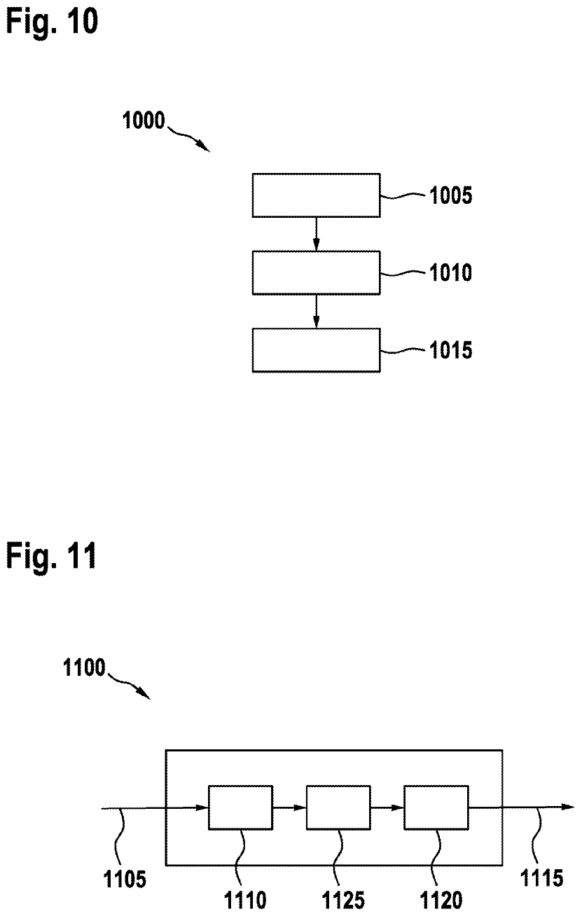

FIG. 10 shows a flow diagram of a method for operating a receiving unit according to one exemplary embodiment; and

FIG. 11 shows a block diagram of an apparatus according to one exemplary embodiment.

In the description hereinafter of useful exemplary embodiments of the present invention, the same or similar reference symbols are used for the elements represented in the various figures and acting in a similar way and the description of these elements is not repeated.

FIG. 1 shows a schematic side representation of a receiving device 100 according to one exemplary embodiment. The receiving device 100 is designed to introduce a fluid into a receiving unit 105 and/or to overlayer the receiving unit 105 with a further fluid, the so-called sealing liquid, on the receiving face 130 at least in subregions thereof and more particularly in the arrangement region of the cavities and more particularly after introduction of the fluid into the receiving unit 105. For this purpose the receiving device 100 has the receiving unit 105 for receiving the fluid, a housing 110 for accommodating the receiving unit 105, a chamber 115 designed to introduce the fluid into the receiving unit 105, and at least one channel 120, designed to carry the fluid to the receiving unit 105 and/or to carry it from the receiving unit 105 and/or to enable venting of the chamber 115 and of the micro-cavities 135, 150. The receiving device 100 optionally has a pump device which is designed to pump the fluid and optionally the sealing liquid through the at least one channel 120. The receiving unit 105 has a receiving element 125 having a receiving face 130 with a hydrophilic surface nature, and at least one micro-cavity 135, which in the receiving element 125 is arranged on the receiving face 130 and is shaped to receive the fluid.

According to this exemplary embodiment, the receiving element 125 is formed, for example, of a silicon substrate. The receiving face 130 is designed for example at least partly as a silicon nitride layer, silicon oxide layer and/or as a silane layer—for example as a polyethylene glycol-silane layer—and this facilitates, for example, penetration of the fluid into the micro-cavity 135. According to this exemplary embodiment the micro-cavity 135 has side walls 140, which are aligned substantially perpendicular to the receiving face 130, being aligned for example at an angle 145 of between 80° and 100° with respect to the receiving face 130. According to an alternative exemplary embodiment, the micro-cavity 135 has a virtually cylindrical shaping. Moreover, optionally, according to this exemplary embodiment the receiving unit 105 has a plurality of further micro-cavities 150, which in the receiving element 125 are arranged on the receiving face 130 and are shaped to receive the fluid. In this case the micro-cavity 135 and the plurality of further micro-cavities 150 are arranged in an arrangement region not represented here, more particularly in a square, circular, rectangular or oval region of the receiving face, more particularly with a mandated distance from the edge of the receiving face, more particularly according to a hexagonal, square or rectangular scheme; more particularly, between the micro-cavity 135 and the plurality of further micro-cavities 150, the receiving face 130 has a hydrophilic surface character. Additionally, optionally, the receiving unit 105 according to this exemplary embodiment has an optically detectable feature 155, which has a defined position relative to the arrangement of the at least one micro-cavity 130. This means that the optically detectable feature 155 according to this exemplary embodiment has a predetermined character in relation to size and optical properties.

In other words a micro-cavity array chip, meaning the receiving unit 105, for aliquoting of a fluid, which is also referred to as sample liquid, i.e., for the filling of the micro-cavities 135, 150 in the receiving unit 105 with the sample liquid, by wetting of the receiving face 130 with the sample liquid and successive wetting of the receiving face 130 with a sealing liquid, where the sample liquid remains at least partly in the micro-cavities 135, 150 of the receiving unit, the implementation of mutually independent reactions in the aliquots, i.e., in the sample liquid partitions present in the micro-cavities 135, 150 after aliquoting of the sample liquid, where these partitions may each contain specific reagents stored in the micro-cavities 135, 150, and also a method for producing the receiving unit 105, are presented. The approach presented here relates, accordingly, to an apparatus for distributing a sample liquid over a multiplicity of compartments, which are also referred to as micro-cavities 135, 150, and implementation of a multiplicity of mutually independent reactions in the micro-cavities 135, 150. More particularly there is distribution of the fluid and implementation of the reactions for example in an automated procedure in a microfluidic system, which according to this exemplary embodiment is referred to as receiving device 100.

As a result of the approach described here, accordingly, a solution is likewise provided which according to this exemplary embodiment, by means of the receiving unit 105, permits simple introduction and storage of, for example, dried reagents in the micro-cavities 135, 150, sufficiently reduces entrainment of the stored reagents during the controlled distribution of the fluid over the micro-cavities 135, 150, exhibits only very low crosstalk of reactions between the various micro-cavities 135, 150, enables (automatable) microfluidic aliquoting of the fluid in the micro-cavities 135, 150, can be produced cost-effectively and/or can be integrated into a receiving device 100, so that fully automated microfluidic processing is achieved.

The receiving device 100 according to this exemplary embodiment possesses in particular the chamber 115 with advantageously predetermined dimensions 160, which is envisaged for the introduction of the fluid into the micro-cavities 135, 150 and/or for the sealing of the micro-cavities 135, 150 with a second fluid which is not miscible with the fluid. The microfluidic chamber 115 according to this exemplary embodiment possesses at least one channel 120, which is also referred to as a supply and/or removal channel and which is intended for controlled carrying of the fluid or fluids to and from the receiving unit 105. In one advantageous configuration of the receiving device 100, it further comprises a channel system, not represented here, and/or a pump apparatus, not represented, to enable fully automated microfluidic processing of the receiving unit 105.

This receiving unit 105 according to this exemplary embodiment has the receiving face 130, which is also referred to as a planar surface and which possesses an arrangement of micro-cavities 135, 150 introduced on the receiving element 125, which is formed from a substrate material. According to this exemplary embodiment this receiving face 130, in particular in an immediate environment around the micro-cavities 135, 150, possesses hydrophilic wetting properties. The micro-cavities 135, 150 according to this exemplary embodiment are notable in particular for virtually perpendicular side walls 140, with the receiving face 130 at the micro-cavities 135, 150, or at openings thereof, enclosing in particular an angle 145 of virtually 90° with respect to the side walls 140 of the micro-cavities 135, 150. Located optionally in the micro-cavities 135, 150 is in particular at least one stored substance, also referred to as reagent or additive. The micro-cavities 135, 150 optionally have a virtually cylindrical shape, which permits particularly simple fabrication of the receiving unit 105. The arrangement of the micro-cavities 135, 150 follows, in particular, a square, hexagonal or rectangular scheme, to enable, optionally, a standardized introduction of reagents into the micro-cavities, more particularly with use of an array spotting system, more particularly a piezo-based precision dispensing system. Merely optionally the receiving face 130 according to this exemplary embodiment additionally possesses the optically detectable feature 155, which, for example, has a defined position relative to the arrangement of micro-cavities (20) and has a suitable character in relation to size and optical properties. As a result the feature 155 is detectable in particular by an optically sensitive apparatus such as a camera of an array spotting system and can be used for defined, fully automated introduction of reagents into the arrangement of micro-cavities 135, 150. Alternatively or additionally to this, the feature 155 can be used for a relative positional determination of the micro-cavities 135, 150, especially in the case where reactions implemented in the micro-cavities 135, 150 are evaluated optically.

The approach presented here describes in summary a receiving unit 105 having a combination of a hydrophilic receiving face 130, with which the fluid comes into contact at least in subregions for the filling of the micro-cavities 135, 150; at least partly perpendicular side walls 140 of the micro-cavities 135, 150, which in particular counteract entrainment of reagents stored in the micro-cavities 135, 150; stored reagents which permit implementation of different, specific detection reactions in the micro-cavities 135, 150; and/or at least one stored additive, such as, for example, a substance which ensures wetting and complete filling of the micro-cavities 135, 150, so that no air is included in the micro-cavities 135, 150, and/or leads to a reduction in the entrainment of the aforementioned reagents stored in the micro-cavities 135, 150; and a use of cavities 135, 150 with a solid bottom. This means no through-holes, thereby facilitating storage of reagents and/or at least one additive in the cavities 135, 150.

According to this exemplary embodiment, the approach presented here, in addition to a microfluidic functionality in relation to the filling and/or the sealing of the reaction compartments, ensures low crosstalk between reactions implemented in the compartments, meaning micro-cavities 135, 150. The approach presented here further describes wetting properties of the receiving face 130, composed for example of silicon nitride, silicon oxide or a hydrophilic silane layer, more particularly a polyethylene glycol-silane layer, the micro-cavities 135 (for example, with polyethylene glycol as dried additive and primers and probes for a molecular DNA detection reaction as dried reagent and/or a silicon oxide layer, silicon nitride layer or a silane layer as hydrophilic surface), and, for example, a flow cell made of polymer, such as of polycarbonate, for example.

Alternatively, for example, a component produced in an alternative method not described here may likewise be used for providing the functionalities stated here, but in that case the receiving unit 105 is somewhat more costly and inconvenient to produce, with, for example, two lithography steps, than the receiving unit 105 produced according to the approach described here.

For preventing or reducing the fluidic crosstalk between adjacent compartments, the prior art makes use in particular of apparatuses which have a hydrophobic surface character between the compartments. This brings with it, however, the disadvantage that the hydrophobic top side makes it more difficult to fill the compartments in the substrate. In particular, according to the prior art—with a hydrophobic top side and a small size of the compartments, in the case, for example, of a lateral dimension/diameter of the compartments in the sub-millimeter range—cavities having sloping side walls, or through-holes, or recesses with a low aspect ratio are used in order to enable simple filling of the compartments with aqueous phases. Measured on the basis of their area, however, cavities having sloping side walls possess a comparatively low volume. This is a disadvantage for implementation of high-multiplex amplification reactions—especially with optical evaluation of the reactions—since on the one hand the desire is for a maximum surface density of reactions proceeding in parallel and on the other hand—because of the small volume of the compartments—only a comparatively weak fluorescence signal is generated, which in the case of optical evaluation leads to a reduced signal-to-noise ratio. Cavities having sloping side walls also make it more difficult to store reagents in them, since the flow profile that develops therein when the compartments are filled with a sample liquid leads preferentially to unwanted entrainment of the stored reagents. Through-holes in turn bring with them the disadvantage that introduction and storage of reagents in the individual reaction compartments is more difficult, as the reagents can be deposited only on the side walls of the through-holes.

FIG. 2A shows a schematic side representation of a receiving unit 105 according to one exemplary embodiment. The receiving unit 105 represented here may correspond to or be similar to the receiving unit 105 described in FIG. 1. According to this exemplary embodiment, the receiving unit 105 is represented merely in an enlarged form, so that at least one stored reagent 200 in accordance with this exemplary embodiment can be perceived in the micro-cavity 135. This means that according to this exemplary embodiment the receiving unit 105 has at least one stored reagent.

Moreover, in accordance with this exemplary embodiment, there is emphasized representation of the fact that a center point of the micro-cavities 135, 150 has the same distance 205 from an adjacent micro-cavity 135, 150 as a center point of the optically detectable element 155 has to the center point of the respectively adjacent micro-cavity 135, 150.

Described in other words is the receiving unit 105 which enables the distribution of the fluid over the micro-cavities 135, 150 and the implementation of a multiplicity of mutually independent reactions in the micro-cavities 135, 150, there being dried reagents 200 stored in the micro-cavities 135, 150. Additionally presented is a method, described in one of the subsequent figures, for producing the receiving unit 105. The receiving unit 105 permits, in particular, reliable introduction of reagents 200 into the micro-cavities 135, 150; reduces entrainment of the reagents 200 stored in the micro-cavities 135, 150 during distribution of the fluid over the micro-cavities 135, 150 sufficiently, to <10%, for example; the receiving device 105 exhibits only very little (<1%) crosstalk of reactions between the various micro-cavities 135, 150 after sealing of the micro-cavities with a suitable sealing liquid; it allows automatable microfluidic aliquoting of the fluid in the micro-cavities 135, 150; and it can be integrated into a microfluidic system, such as the receiving device 100.

According to this exemplary embodiment, therefore, the receiving unit 105 has the micro-cavities 135, 150 which serve to form microfluidic compartments. These micro-cavities 135, 150 have virtually perpendicular side walls, especially at an interface to a side of the receiving unit 105 that comes into contact with the fluid, and possess, in particular, stored reagents 200 and also a restricted aspect ratio, in order, for example, to prevent unwanted inclusion of air in the micro-cavities 135, 150 during the filling of the micro-cavities 135, 150 with the fluid and to enable complete filling of the micro-cavities 135, 150 with the fluid. The receiving face of the receiving unit 105, which comes into contact with the fluid and via which the micro-cavities 135, 150 are filled, has, according to this exemplary embodiment, a hydrophilic surface character, especially in the immediate environment around the micro-cavities 135, 150, to enable the fluid to penetrate the micro-cavities 135, 150. In a particularly advantageous way, the receiving unit 105 may be part of a receiving device as described in FIG. 1, in order, for example, to enable fully automated microfluidic processing and optionally implementation of reactions in the micro-cavities 135, 150. As a result, this exemplary embodiment enables reliable filling as a result of the hydrophilic surface character of the receiving face, bordering the micro-cavities 135, 150, of the receiving unit 105, storage of reagents 200 and/or of an additive in the micro-cavities 135, 150, and also a suitable aspect ratio of the micro-cavities 135, 150 with the suitably charactered fluid.

Furthermore, by virtue of the (virtually) perpendicular side walls of the micro-cavities 135, 150, in combination, for example, with a suitable additive, entrainment of the stored reagents 200 during the filling with the fluid can be minimized to <10%, for example. This is the case in particular in comparison to micro-cavities 135, 150 having sloping side walls, with a geometry which, in conjunction with the flow profile that develops, leads in principle to greater entrainment of reagents 200 stored in the micro-cavities 135, 150. Furthermore, with the approach presented here, by means, for example, of sealing of the micro-cavities 135, 150, after the micro-cavities 135, 150 have been filled, for example, with a suitable second fluid, which is not miscible with the fluid, it is possible to achieve only a low level of crosstalk, <1% for example, between adjacent reaction compartments during the implementation of chemical reactions in the micro-cavities 135, 150. Accordingly it is possible to implement mutually independent, spatially separate reactions in the micro-cavities 135, 150. Because of the resultant geometric multiplexing, for example, when suitable target-specific detection reagents are stored in the micro-cavities 135, 150, a fluid can be studied for a multiplicity of different targets. Furthermore, according to this exemplary embodiment, by virtue of the receiving device, a fully automated microfluidic processing is enabled in a particularly advantageous way. The receiving device used for processing the receiving unit 105 may in particular be produced cost-effectively from a polymer or from a combination of polymer materials. In this way the functionality provided by the receiving unit 105 is realized in compact lab-on-chip systems which can be used in molecular laboratory diagnostics.

FIG. 2B shows a schematic representation of the plan view of a receiving unit 105 according to one exemplary embodiment. The receiving unit 105 possesses micro-cavities 135, 150 which are arranged in a circular arrangement region 600 according to a hexagonal scheme. The outer border (marked by the dot-dashed line) of the arrangement region 600 of the micro-cavities 135, 150 also has a mandated minimum distance from the edge of the receiving face of the receiving unit 105. This edge region can be utilized in particular to enable easy handling of the receiving unit 105 with an automatic charger (pick-and-place robot) and so, for example, to enable easy fabricatability of an above-described receiving device 100, for example. In this exemplary embodiment the receiving unit 105 additionally possesses optically detectable features 155, or, otherwise designated, reference markings, which can be used, for example, for unambiguous assignment and/or symbolic identification of the micro-cavities 135, 150 and/or can be employed, for example, for positional determination of the receiving unit 105 in processing apparatuses having optical detection systems, such as for example for positional determination in a precision dispensing system for the automated introduction of reagents into the micro-cavities 135, 150 and/or, for example, for positional determination in a processing apparatus which by means of an optical system can be used in particular for the detection of fluorescence signals and which is able for example to detect the fluorescence signal profile of, for example, biochemical reactions in the micro-cavities 135, 150.

FIG. 3 shows a schematic side representation of a receiving unit 105 according to one exemplary embodiment. The receiving unit 105 represented here may correspond to or be similar to the receiving unit 105 described in FIG. 1 or 2. The only difference is the enlarged representation according to this exemplary embodiment, such that the optically detectable element is not depicted.

FIG. 4 shows a schematic representation of different stages of intermediates in a possible production process 400 for a receiving unit 105 according to one exemplary embodiment. The receiving unit 105 in this case may correspond to or be similar to the receiving unit 105 described in one of FIGS. 1 to 3 and can therefore also be used in a receiving device as described in FIG. 1.

Serving here as substrate material according to this exemplary embodiment is a receiving element 125 of silicon, which is also referred to as a silicon wafer. First of all the hydrophilic surface character on the substrate material is produced on the receiving face 130. This surface according to this exemplary embodiment is more particularly a silicon nitride surface, which can be generated on the silicon substrate by means, for example, of a method for the deposition of silicon oxide, silicon nitride and polysilicon, and also of metals, said method also being referred to as low-pressure chemical vapor deposition (LPCVD). Especially suitable here in accordance with this exemplary embodiment is a layer system composed for example of 50 nm SiO₂ and 140 nm Si₃N₄ to produce a low-strain Si₃N₄ layer with effective attachment to the silicon substrate. Silicon nitride is suitable as a surface coating according to this exemplary embodiment because it has, in particular, hydrophilic wetting properties. After pretreatment with hexamethyldisilazane (HMDS), for example, a photoresist 405 is applied, which serves as a mask for etching of the micro-cavities into the silicon substrate. According to this exemplary embodiment, after exposure 410 of the photoresist 405 for definition of the structures to be etched, the photoresist is developed. Subsequently, according to this exemplary embodiment, by means of dry CF₄ etching 415, for example, the Si₃N₄ and SiO₂ on the exposed regions 420 are removed. By means of deep reactive ion etching 425, for example, the micro-cavities 135, 150 are introduced into the silicon substrate. Deep reactive ion etching 425 is optimized advantageously in process terms for production of microstructures having virtually perpendicular side walls. By treatment in, for example, an oxygen plasma 430, the remaining photoresist 405 is removed. According to this exemplary embodiment, one or more reagents 200 are introduced into the micro-cavities 135 by means, for example, of a piezo-based precision dispensing system or an array spotting system. With particular advantage a production process 400 of this kind can take place at wafer level, thereby enabling particularly cost-effective and parallelized production of the receiving unit 105. Singularization of the receiving units 105 produced in a parallelized process may be accomplished, for example, by means of sawing, breaking, or another singularization method, for example a laser-based method, such as, for example, the method referred to as Mahoh dicing, in particular after the introduction of the reagents 200 into the micro-cavities 135.

FIG. 5 shows a flow diagram of a method 500 for producing a receiving unit according to one exemplary embodiment. The method 500 represented here may comprise eight substeps 502, in accordance with the production process 400 described in FIG. 4, and is able to produce a receiving unit as was described in one of FIGS. 1 to 3. According to this exemplary embodiment, the method 500 comprises a step 505 of providing the receiving face and a step 510 of introducing the at least one micro-cavity into the receiving face for receiving the fluid, to produce the receiving unit.

According to one exemplary embodiment the steps 505, 510 and/or substeps 502 of the method 500 may, in one advantageous version, be omitted and/or implemented in a changed order.

FIG. 6A shows a perspective representation of a semifinished product during the production of receiving units 105 according to one exemplary embodiment. The receiving unit 105 represented here may correspond to or be similar to the receiving unit 105 described in one of FIGS. 1 to 3. According to this exemplary embodiment, the plurality of further micro-cavities 150 is shaped to receive the fluid. According to this exemplary embodiment, the micro-cavity 135 and the plurality of further micro-cavities 150 are arranged in a virtually square arrangement region 600, in a way such that they follow a square scheme. The receiving face 130 here, in particular between the micro-cavity 135 and the plurality of further micro-cavities 150, has a hydrophilic surface character.

According to this exemplary embodiment it becomes clear, moreover, that the receiving unit 105, as well as the micro-cavity 135 and the plurality of further micro-cavities 150, has a further plurality 605 of micro-cavities shaped to receive the fluid. According to this exemplary embodiment, the further plurality 605 of micro-cavities is arranged in a further arrangement region 610 such that they form a square, rectangular or hexagonal form, more particularly wherein, between the arrangement region 600 and the further arrangement region 610, a spacing region 615 is arranged in which there are no micro-cavities 135, 150, 605. According to this exemplary embodiment, the spacing region 615 has a width which corresponds, for example, at least to twice the minimum distance of adjacent micro-cavities of the arrangement region 600 or to the further arrangement region 610.

In order words, according to this exemplary embodiment, a representation of a processed silicon wafer having micro-cavities 135, 150, 605 is reproduced, after, for example, implementation of the method described in FIG. 5 for producing a receiving unit 105.

FIG. 6B shows a perspective representation of a silicon substrate having predetermined breakage points introduced, for forming a plurality of receiving units before singulation of the substrate. The receiving units each have a micro-cavity and a plurality of further micro-cavities, which are arranged in a (virtually) circular arrangement region according to a hexagonal scheme. Additionally the receiving units each possess optically detectable features for the purpose, for example, of introducing reagents into the micro-cavities by means of a precision dispensing system and/or for determining position of the receiving unit in a detector and/or for unambiguously identifying the micro-cavities.

FIG. 7 shows a representation for explaining the procedure for ascertaining a reaction result 700 of a polymerase chain reaction, obtained in a receiving unit 105 according to one exemplary embodiment. A reaction result 700 of this kind may be obtained in a receiving unit 105 as has been described in one of the above-presented FIGS. 1 to 3.

In other words, for example, the sample liquid used, also referred to as fluid, was a so-called PCR master mix, which contained a target gene with a concentration of 10 initial copies per micro-cavity (25 nl). The PCR master mix additionally contained a target-specific TaqMan fluorescent probe (Cy3) which indicates amplification of the target gene.

Illustrated schematically in FIG. 7a is a fluorescence micrograph of the fluid distributed over the micro-cavities of the receiving unit 105, which may also be referred to as apparatus, the micrograph having been recorded during temperature cycling for the implementation of the polymerase chain reactions. The micro-cavities containing fluid in which a significant quantity of the PCR product has already been generated appear pale, owing for example to the cleaving of the fluorescence probe. According to this exemplary embodiment, the micro-cavities without a significant quantity of the PCR product appear dark.

FIG. 7b shows a signal profile belonging to the micro-cavity “F3”, which exhibits a sigmoidal rise, which is attributable to the process of a polymerase chain reaction in this micro-cavity.

FIG. 7c shows normalized, sigmoidally fitted amplification curves for the individual micro-cavities, collected together in a graph. According to this exemplary embodiment, 89 of the 96 micro-cavities show a rise in the fluorescence signal at a mean ci value—meaning PCR cycle at the inflection point of the sigmoidal signal rise—of 31.53 with a standard deviation of 0.81 temperature cycles. According to this exemplary embodiment, 4 micro-cavities show no significant rise in the fluorescence signal during temperature cycles. The remaining 3 micro-cavities exhibit a rise in the fluorescence signal at ci values>45 temperature cycles. FIG. 7d illustrates this using a histogram of the ci values.

FIG. 7e illustrates this using a map with a spatial distribution of the ci values in a suitable false-color representation. On the basis of FIGS. 7c, d, e it is clear that in a large proportion of the micro-cavities (92.71%), amplification takes place in a ci value range between 30 and 34 temperature cycles. The fluctuation in the ci values measured may be attributed partly to the statistical fluctuation of the number of copies initially present in the micro-cavities. On the basis of a binomial distribution, a fluctuation of between about 2 and 16 initial copies per micro-cavity, corresponding roughly to the 4 PCR cycles stated above, can be assumed for a mean initial copy number of 10 copies per micro-cavity. The number of negative cavities, on the other hand, cannot be attributed solely to the statistical fluctuation of the number of copies in the cavities on the basis of the binomial distribution. A decisive part is played here by the amplification characteristics of the detection reaction, especially the sensitivity, the limit of detection. The micro-cavities with a negative signal profile are due to the fact that there is not always amplification in the case of a small number of copies initially present in a micro-cavity. The sensitivity of the detection reaction selected is too low for this purpose. In additional measurements, a statistical detection limit for the reaction used here was ascertained, at what is called a limit of detection of about 2.5 initial copies per micro-cavity. According to this exemplary embodiment, moreover, the micro-cavities with a negative signal profile show that in these cavities, even after progression of the amplification reaction in the adjacent micro-cavities, there is no significant copy number generated by means of a PCR. Accordingly, these micro-cavities may be employed as an indicator of crosstalk between adjacent reaction compartments. In particular the 3 micro-cavities in which a delayed PCR takes place are potentially relevant for this purpose. The delaying of the sigmoidal rise by more than 10 PCR cycles, indeed, according to this exemplary embodiment, cannot be attributed to the initial statistical fluctuation of the copy numbers.

Instead, these are possibly delay-positive or false-positive amplification reactions, possibly initiated as a result of the crosstalk between amplification reactions in adjacent micro-cavities. On the basis of the fact that the array exhibits micro-cavities with a negative signal profile, and also of the fact that the rise of the false-positive reactions occurs only with a delay of 10 PCR cycles, it may be concluded, according to this exemplary embodiment, that the crosstalk between reactions implemented in adjacent micro-cavities is

$$< \frac{1}{{2}^{10}} \approx 0.1 \%$$

per amplification cycle. In agreement with further, comparable tests, the experiment therefore shows illustratively that the receiving unit 105 is suitable for implementation of (geometrically) multiplex amplification reactions without significant crosstalk between adjacent reaction compartments, also referred to as micro-cavities.

FIG. 8 shows a schematic representation of a reaction result 800 obtained in a receiving unit 105 according to one exemplary embodiment, after an entrainment test. A reaction result 800 of this kind can be obtained in a receiving unit 105 as described in one of the above-presented FIGS. 1 to 3.

According to this exemplary embodiment, entrainment of reagents stored in the micro-cavities is studied, this entrainment possibly occurring in the course of so-called microfluidic processing of the receiving unit 105, meaning in the course of controlled filling of the micro-cavities with a fluid and subsequent controlled sealing of the micro-cavities with a second fluid. For this purpose, according to this exemplary embodiment, copies of a target gene, an ABL gene for example, were introduced into (almost) every second micro-cavity, in the form of a chessboard-like pattern, by means of a precision dispensing system/array spotting system, and were stored for example in dried form together with polyethylene glycol (PEG) as additive (see FIG. 8a).

FIG. 8b shows a schematic illustration of a fluorescence micrograph made during temperature cycling. The micrograph was made after a significant rise in the fluorescence signal was already apparent in a number of micro-cavities, indicating the generation of a PCR product. In the micro-cavities in which about 100 copies of template DNA of the target gene were stored (patterned filling in FIG. 8a), the fluorescence signal observable is greater than in the micro-cavities without stored template DNA (no filling in FIG. 8a). This points accordingly to selective amplification and hence to only a low level of entrainment of stored reagents during the microfluidic processing.

Shown additionally in FIG. 8c, according to this exemplary embodiment, is a spatial distribution of the ci values. In the micro-cavities in which in each case 100 copies of template DNA were stored, reliable amplification is observable at ci values between 26.8 and 28.8 temperature cycles. In the remaining micro-cavities, conversely, mostly no amplification can be observed within 50 temperature cycles. Only in 8 micro-cavities is there a delayed amplification, with a delay of more than 4 temperature cycles. Accordingly the entrainment of reagents stored in the micro-cavities of the receiving unit 105, occurring during the microfluidic processing of the receiving unit 105, can be quantified at a maximum of about ½⁴= 1/16=6.25%. The receiving unit 105 is therefore likewise suitable for the implementation of multiplex amplification reactions wherein target-specific reagents, such as primers and probes, for example, are stored in the micro-cavities.

FIG. 9 shows a representation for explaining the procedure for ascertaining a reaction result 900, obtained in a receiving unit 105 according to an exemplary embodiment, for a multiplex test. A reaction result 900 of this kind may be obtained in a receiving unit 105 as described in one of the above-presented FIGS. 1 to 3. According to this exemplary embodiment, the reaction result 900 represented is the result from a multiplex test with stored primers and probes. For this purpose, according to this exemplary embodiment, target-specific primers and probes were stored in respectively 12 micro-cavities of the receiving unit 105, in dried form, for example, together with polyethylene glycol as additive, these primers and probes addressing the two target genes “ABL” and “e13a2”. The probes possessed fluorophores corresponding to “Cy3” and “Cy5”, as outlined in FIG. 9a. The sample liquid introduced was a PCR master mix having a concentration of 100 copies of ABL template DNA per micro-cavity, 25 nl for example, and processing took place.

FIGS. 9b, c illustrate schematically two fluorescence pictures made before and after thermocycling. The representations shown are each made up of two individual fluorescence micrographs, made with the filter sets represented in the horizontal patterning corresponding to the fluorophore Cy3 and with the filter sets represented in the vertical patterning corresponding to the fluorophore Cy5. The pictures do not indicate any significant entrainment of reagents stored in the micro-cavities or crosstalk between reactions which occur in adjacent micro-cavities. Only the micro-cavities with stored primers and probes display a significant fluorescence signal. According to this exemplary embodiment, therefore, the pictures confirm the previous experiments described in FIG. 8 in terms of the low entrainment during the microfluidic processing and the negligible crosstalk between adjacent micro-cavities of the apparatus presented here.

Shown in FIG. 9d is the sigmoidal signal profile of the micro-cavity “G4”, which indicates a positive detection of the ABL template DNA in the sample liquid by means of polymerase chain reaction.

FIG. 9e shows a map of a spatial distribution of the ci values. Amplification can be observed in precisely the 12 micro-cavities containing stored primers and probes for the ABL target gene, with ci values in the range between 27.3 and 29.6.

FIG. 9f shows an associated graph with the normalized amplification curves of the twelve micro-cavities. In summary the measurement underscores the outstanding suitability of the receiving unit 105 for implementation of geometrically high multiplex sample analyses by means of molecular-diagnostics amplification methods.

FIG. 10 shows a flow diagram of a method 1000 for operating a receiving unit according to one exemplary embodiment. The method 1000 may be used, for example, for a receiving device as described in FIG. 1. This method 1000 comprises a step 1005 of the filling and sealing of the at least one micro-cavity with a fluid or with a second (sealing) fluid, which, for example, has only very little or no miscibility with the fluid; a step 1010 of the implementing of at least one possible reaction in the at least one micro-cavity to obtain a reaction result; and a step 1015 of the evaluating of the reaction result.

In other words the micro-cavities of the receiving unit are filled with the fluid. Subsequently the micro-cavities already filled beforehand with the fluid are sealed with a second (sealing) fluid, which has only very slight or no miscibility with the fluid. More particularly the second fluid, also referred to as sealing liquid, is a fluorinated hydrocarbon. Furthermore, according to this exemplary embodiment, reactions independent of one another are implemented, more particularly amplification reactions, such as polymerase chain reactions or isothermal amplification reactions, for example, for the detection of at least one target gene, for example, in the micro-cavities of the receiving unit. Reaction conditions suitable for these purposes are optionally produced by external action, such as introduction of heat or removal of heat, for example.

In one particularly preferred embodiment steps 1005, 1010, 1015 take place in automated form in a processing unit envisaged for the processing of the receiving device.

According to one exemplary embodiment, steps of the method 1000 may, in one advantageous version, be omitted and/or carried out in a changed sequence.

FIG. 11 shows a block diagram of an apparatus 1100 according to one exemplary embodiment. According to this exemplary embodiment the apparatus 1100 is designed for the implementation or activation of one of the methods described in FIG. 5 or 10. The apparatus 1100 is designed to read—in an input signal 1105 by means of a read—in unit 1110, for example, and to provide a control signal 1115 by means of a providing unit 1120. According to this exemplary embodiment, the apparatus optionally has an evaluating unit 1125 designed to evaluate information represented by the read—in signal 1105.

If an exemplary embodiment comprises an “and/or” conjunction between a first feature and a second feature, this should be read as meaning that according to one embodiment, the exemplary embodiment has both the first feature and the second feature, and, according to a further embodiment, it has either only the first feature or only the second feature.

Illustrative Specifications are Stated Below:

Thickness of the receiving element (125): 100 μm to 3000 μm, preferably 300 μm to 1000 μm

Lateral dimensions of the receiving element (125) or of the receiving face (130): 3 mm×3 mm to 30 mm×30 mm, preferably 5 mm×5 mm to 15 mm×15 mm

Number of the micro-cavity (135) and of the further micro-cavities (150):

2 to 2000, preferably 50 to 500

Volume of the micro-cavity (135):

1 nl to 100 nl, preferably 5 nl to 40 nl

Diameter of the micro-cavity (135):

100 μm to 500 μm, preferably 250 μm to 400 μm

Depth of the micro-cavity (135):

100 μm to 500 μm, preferably 200 μm to 300 μm

Aspect ratio (ratio of depth to diameter) of the micro-cavity (135):

0.3 to 1.0, preferably 0.6 to 0.7

Distance of the edges of the micro-cavity (135) and at least one further micro-cavity (150) bordering the micro-cavity (135):

70 μm to 300 μm, preferably 100 μm to 200 μm

Contact angle of water on the receiving face (130): <10° to 75°, preferably <10° to 40°

Reagents stored in the micro-cavities (135, 150): target-specific primers and probes, template DNA; additive: polyethylene glycol (PEG) with molecular weight of, for example, 6000 or 2000 and a concentration in the solution of 2-5% (w/v)

Fluid (Sample Liquid):

master mix for an amplification reaction such as a PCR or an isothermal amplification method, or constituents thereof, more particularly master mix without primers and/or probes which are present in the micro-cavities (135, 150)

Second Fluid (Sealing Liquid):

fluorinated hydrocarbon, such as 3M Fluorinert FC-40, Fluorinert FC-70, or Novec 7500

Flow rate for the filling and sealing of the micro-cavities (135, 150) of the receiving unit (105) in a receiving device (100) for micro-cavities (135, 150) having diameter of 350 μm and depth of 240 μm, where the chamber (115) has suitable dimensions such as 7 mm×7 mm×1 mm (volume˜50 μl): 5-10 μl/s

1. A receiving unit for receiving a fluid, the receiving unit comprising:
a receiving element having a receiving face and at least one micro-cavity defined in the receiving element on the receiving face, the at least one micro-cavity being shaped to receive the fluid,
wherein the receiving face has a hydrophilic surface character in at least one subregion bordering the at least one micro-cavity.

2. The receiving unit as claimed in claim 1, wherein the at least one micro-cavity has a side wall aligned substantially perpendicular to the receiving face.

3. The receiving unit as claimed in claim 1, wherein the receiving face is configured at least partly as a silicon nitride layer or silicon oxide layer or a silane layer.

4. The receiving unit as claimed in claim 1, wherein the receiving element is formed of a silicon substrate.

5. The receiving unit as claimed in claim 1, wherein:
a plurality of further micro-cavities, are defined in the receiving element on the receiving face and are shaped to receive the fluid, and
the micro-cavity and the plurality of further micro-cavities are aligned in an arrangement region in a square, rectangular, round, oval, circular or hexagonal form.

6. The receiving unit as claimed in claim 1, wherein the micro-cavity contains at least one stored reagent and/or additive.

7. The receiving unit as claimed in claim 1, wherein the receiving face has an optically detectable feature which has a predefined position relative to an arrangement of the at least one micro-cavity.

8. A receiving device comprising:
the receiving unit as claimed in claim 1;
a housing in which the receiving unit is accommodated;
a chamber configured to introduce a fluid into the receiving unit; and
at least one channel configured to carry the fluid to the receiving unit and/or from the receiving unit.

9. A method for producing a receiving unit, the method comprising:
introducing a micro-cavity into a receiving face of a receiving element of the receiving unit, the micro-cavity configured to receive a fluid, so as to produce the receiving unit,
wherein the receiving face has a hydrophilic surface character in at least one subregion bordering the micro-cavity.

10. The method for producing the receiving unit as claimed in claim 9, the introducing of the micro-cavity comprising using a deep reactive ion etching method.

11. A method for operating a receiving unit having a receiving element with a receiving face and at least one micro-cavity defined in the receiving element on the receiving face, the at least one micro-cavity being shaped to receive a fluid, the receiving face having a hydrophilic surface character in at least one subregion bordering the at least one micro-cavity, the method comprising:
filling the at least one micro-cavity with the fluid; sealing the filled micro-cavity with a second fluid;
implementing to enable at least one reaction in the micro-cavity and to obtain a reaction result; and
evaluating the reaction result.

12. An apparatus configured to perform and/or activate the steps of the method as claimed in claim 11 in corresponding units.

13. The method as claimed in claim 11, wherein the method is implemented in a computer program configured to perform and/or activate the filling of the at least one micro-cavity, the implementing of the at least one reaction, and the evaluating of the reaction result.

14. The method as claimed in claim 11, wherein the computer program is stored on a machine-readable storage medium.

15. The receiving unit as claimed in claim 5, wherein the receiving face has the hydrophilic surface character between the micro-cavity and the plurality of further micro-cavities.

16. The receiving unit as claimed in claim 7, wherein the optically detectable feature has a predetermined character in relation to its size, shape and/or optical properties.
